(19) United States
(12) Patent Application Publication
(10) Pub. No.: US 2021/0014242 A1
(43) Pub. Date: Jan. 14, 2021

(54) PROTECTION AGAINST MALICIOUS ATTACKS PROPAGATED VIA EMAILS

(71) Applicant: Quick Heal Technologies Limited, Pune (IN)

(72) Inventor: Himanshu Dubey, Pune (IN)

(21) Appl. No.: 16/551,800

(22) Filed: Aug. 27, 2019

(30) Foreign Application Priority Data
Jul. 12, 2019 (IN) 201921028082

(51) Int. Cl. H04L 29/06; H04L 12/58

(52) U.S. Cl. CPC H04L 63/145; H04L 51/12; H04L 63/1425; H04L 63/1416; H04L 51/08

(57) ABSTRACT

An aspect of the present disclosure protects users from malicious attacks propagated via emails. In one embodiment, a reputation server identifies a (first) set of recipients of an email who have opened the email, and then computes a reputation score for the email based on hygiene scores of the set of recipients. The hygiene score of a recipient is a measure of the infections caused due to the recipient's interactions with prior email communications, while the computed reputation score indicates a probability of malicious attacks being propagated via the email The reputation server then provides the reputation score for the email to another (second) set of recipients of the email. When the email contains a link or an attachment, the reputation server identifies the (first) set of recipients who have opened the email and accessed the link or the attachment contained in the email.

### PRIORITY CLAIM

The instant patent application is related to and claims priority from the co-pending India provisional patent application entitled, “PROTECTION AGAINST EMAIL BASED CYBER-ATTACKS USING WISDOM OF CROWD”, Serial No.: 201921028082, Filed: 12 Jul. 2019, which is incorporated in its entirety herewith.

### BACKGROUND OF THE DISCLOSURE

### Technical Field

The present disclosure relates generally to computer security, and more specifically to protection against malicious attacks propagated via emails.

### Related Art

Email refers to an electronic communication sent by a sender to one or more recipients, with intermediate email servers buffering and permitting the recipients to access their respective emails at their convenience. Emails are often accessed by the recipients on email portals (e.g., gmail.com, mail.yahoo.com, etc.) using a browser application or by downloading onto email client applications (e.g., Outlook Express available from Microsoft Corporation, Thunderbird available from Mozilla Foundation, etc.).

Malicious attacks are often propagated via emails. A malicious attack causes harms such as technical damage to the computer from which the email is being accessed, unauthorized transmission of data, etc. Typically, the attack is triggered when the recipient opens an email, and/or accesses a link (by clicking) or attachment (by opening) contained in the email.

Aspects of the present disclosure provide for protection against such malicious attacks propagated via emails.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which protection against malicious attacks propagated via emails is provided according to an aspect of the present disclosure.

FIG. 3 is a block diagram illustrating the manner in which protection against malicious attacks propagated via emails is implemented in one embodiment.

FIGS. 4A and 4B together depicts sample portions of user data maintained for email communications in one embodiment.

FIGS. 5A-5C depicts sample user interfaces provided to users accessing email communications in one embodiment.

FIG. 6 is a block diagram illustrating the manner in which protection against malicious attacks propagated via emails is provided across multiple enterprises in one embodiment.

FIG. 7 is a block diagram illustrating the details of digital processing system 800 in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number. Detailed Description of the Embodiments of the Disclosure

### 1. OVERVIEW

An aspect of the present disclosure protects users from malicious attacks propagated via emails. In one embodiment, a reputation server identifies a (first) set of recipients of an email who have opened the email, and then computes a reputation score for the email based on hygiene scores of the set of recipients. The hygiene score of a recipient is a measure of the infections caused due to the recipient's interactions with prior email communications, while the computed reputation score indicates a probability of malicious attacks being propagated via the email The reputation server then provides the reputation score for the email to another (second) set of recipients of the email.

According to another aspect of the present disclosure, when an email contains a link or an attachment, the reputation server identifies the (first) set of recipients who have opened the email and accessed the link or attachment contained in the email.

According to one more aspect of the present disclosure, the reputation server after performing the identifying and computing at a time instance, continues to monitor the email to identify a third set of recipients who have opened the email at another time instance after the time instance. The reputation computes a new value for the reputation score based on hygiene scores of the third set of recipients and updates the reputation score for the email to the new value.

According to the yet another aspect of the present disclosure, when the email is addressed to multiple recipients, the second/another set of recipients of the email includes at least some recipients not contained in the set of recipients. It may be appreciated that the second set of recipients includes (some) recipients that have not yet opened the email, and who may accordingly be discouraged to open the emails based on the reputation score provided to them. By proactively preventing users from opening emails that have a high probability of causing malicious attacks, the reputation server provides additional protection from malicious attacks propagated via emails.

According to one more aspect of the present disclosure, the first set of recipients belongs to a first enterprise, while the second set of recipients belongs to a second enterprise. As such, the reputation server facilitates protection against malicious attacks propagated via emails across multiple different enterprises.

According to an aspect of the present disclosure, a recipient is deemed to have a positive hygiene score if the recipient has never caused an infection in a pre-determined duration (e.g. last year) and a negative hygiene score if the recipient has been a cause of at least one infection in the pre-determined duration. The reputation score for an email is computed as a negative value if the number of recipients having negative hygiene score in the first set of recipients is greater than the number of recipients having positive hygiene score in the first set of recipients. It may be appreciated that a negative value of the reputation score indicates a high probability of a malicious attack being propagated via the email.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. EXAMPLE ENVIRONMENT

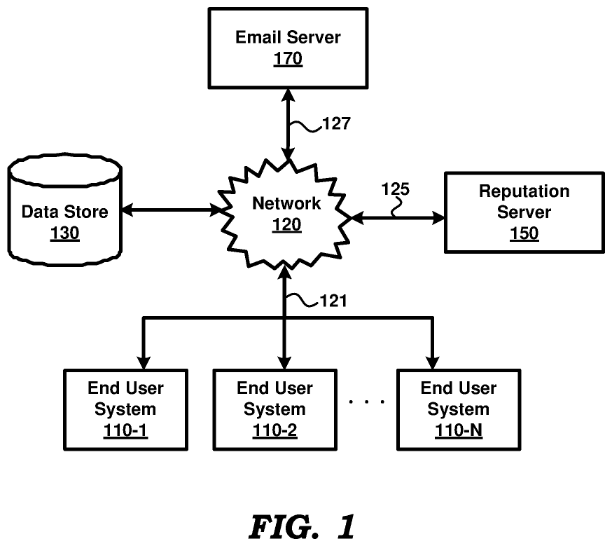

FIG. 1 is a block diagram illustrating an example environment (computing system) in which several aspects of the present disclosure can be implemented. The block diagram is shown containing end user systems 110-1 through 110-N (N representing any arbitrary positive number), network 120, data store 130, reputation server 150 and email server 170. End user systems 110-1 to 110-N are collectively or individually referred by referral numeral 110, as will be clear from the context.

Merely for illustration, only representative number/type of blocks is shown in FIG. 1. Many environments often contain many more blocks, both in number and type, depending on the purpose for which the environment is designed. Each block of FIG. 1 is described below in further detail.

Network 120 represents a data network providing connectivity between client systems 110-1 to 110-N, data store 130, reputation server 150 and email server 170. Network 120 may encompass the world-wide connected Internet. Network 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is to be directed to a target system when the destination IP address of the packet is set to the IP address of the target system, such that the packet is eventually delivered to the target system by network 120. When the packet contains content such as port numbers, which specifies a target application, the packet may be directed to such application as well.

Each of end user systems 110-1 to 110-N represents a system such as a personal computer, workstation, mobile device, computing tablet etc., used by end users to generate (user) requests directed to the various applications executing in server systems such as reputation server 150 and email server 170. The requests may be generated using appropriate user interfaces (e.g., web pages provided by an application executing in the server system, a native user interface provided by a portion of an application downloaded from the server system, etc.). In general, end user system 110 sends a user request containing one or more tasks and may receive the corresponding responses (e.g., embedded in web pages) containing the results of execution of the tasks. The web pages/responses may then be presented to the user at end user systems 110-1 to 110-N by client applications such as the browser.

Data store 130 represents a non-volatile (persistent) storage and provides for storage and retrieval of data by applications executing in other systems such as reputation server 150 and email server 170. Data store 130 may be implemented as a corresponding database server using relational database technologies and accordingly provide storage and retrieval of data using structured queries such as SQL (Structured Query Language). Alternatively (or in addition), data store 130 may be implemented as a corresponding file server providing storage and retrieval of data in the form of files organized as one or more directories, as is well known in the relevant arts.

Each of reputation server 150 and email server 170 represents a server system, such as a web/application server, executing one or more software applications. A server system receives a user request from an end user system 110 and performs the tasks requested (in the user request). The server system may use data stored internally (for example, in a non-volatile storage/hard disk within the server system), external data (e.g., maintained in a data store such as data store 130) and/or data received from external sources (e.g., from the user) in performing the requested tasks. The server system then sends the result of performance of the tasks to the requesting end user system (one of 110) as a corresponding response to the user request. The results may be accompanied by specific user interfaces (e.g., web pages) for displaying the results to the requesting user.

In one embodiment, email server 170 executes email server applications (hereinafter referred to as “server application”) such as Microsoft Exchange Server available from Microsoft Corporation, James Enterprise Mail Server available from Apache Software Foundation, etc. that handle and deliver email communications over a network (such as 120). In particular, email server 170 receives email communications from end user systems 110 or various other servers (not shown) via network 120, and stores (e.g. in data store 130) the emails until accessed by the respective recipients (using corresponding end user systems). Email server 170 may also serve as an outgoing email server for users to send emails to other users in the same network (120) or other severs (not shown).

End user systems 110 sends and receives emails via email server 170 using protocols such as Simple Mail Transfer Protocol (SMTP), Internet Message Access Protocol (IMAP), Post Office Protocol version 3 (POP3), etc., well known in the relevant arts. End user systems 110 may accordingly execute email clients Access to the emails available on email server 170 may be facilitated using a browser application and/or email client applications (hereinafter, collectively referred to as “email clients”) such as Outlook Express available from Microsoft Corporation, Thunderbird available from Mozilla Foundation, etc., as noted above.

The users may thereafter use the email clients to open the email, view the content of the email and interact with the content of the email (e.g. click on a link contained in the email, open an attachment included in the email). As noted above, the accessing and opening of emails may trigger malicious attacks on the end user systems 110 causing harm to the recipient's personal information/end user system.

Reputation server 150, provided according to several aspects of the present invention, provides protection against such malicious attacks propagated via emails as described below with examples.

### 3. PROTECTING AGAINST MALICIOUS ATTACKS PROPAGATED VIA EMAILS

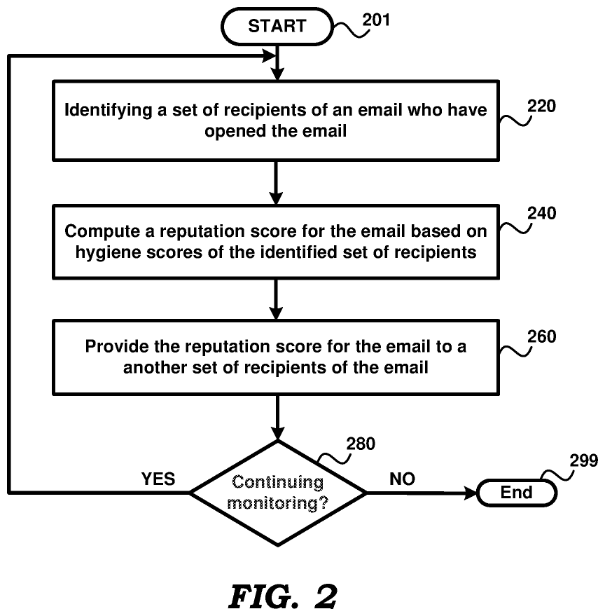

FIG. 2 is a flow chart illustrating the manner in which protection against malicious attacks propagated via emails is provided according to an aspect of the present disclosure. The flowchart is described with respect to the systems of FIG. 1, in particular reputation server 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 220.

In step 220, reputation server 150 identifies a set of recipients of an email who have opened the email. An email is deemed to be opened by a recipient, when the content of the email is displayed (on a display unit associated with end user systems 110, not shown in FIG. 1) to the recipient. Typically, opening an email entails selection of the email for viewing the content. In some environments, an opened email is also referred to as an “email read” by the user/recipient.

The recipients may have opened/read the email using a corresponding email client (browser or email client application) executing in end user systems 110. Each of email server 170 and end user systems 110 may accordingly send an indication to reputation server 150 when the email is opened/read by a corresponding user/recipient, with reputation server 150 identifying the set based on the indications received.

As noted above, the user/recipient may use the email clients to interact with the content of the email after opening the email. When the email contains a link or an attachment, reputation server 150 identifies the set of recipients who have opened the email and also accessed the link (by clicking) or the attachment (by opening) contained in the email.

In step 240, reputation server 150 computes a reputation score for the email based on hygiene scores of the identified set recipients. The computed reputation score indicates a probability of malicious attacks being propagated via the email. In other words, a first value for the reputation score may indicate a high probability of the occurrence of a malicious attack if the email is opened or interacted with, while a second value for the reputation score may indicate a low probability.

The hygiene score of a user/recipient is a measure of the infections caused by the user due to his/her interactions (for example, opening an email, clicking a link, opening an attachment contained in an email) with prior email communications. A user is deemed to have caused an infection if an earlier interaction of the user triggered a malicious attack on an end user system and that the malicious attack resulted in a harm to the end user system or user. The hygiene score may accordingly be a measure of the infections caused and corresponding extent of harm(s). In an embodiment, the hygiene score indicates whether the user/recipient has caused an infection (or not) due to his/her previous interactions in a pre-determined duration (such as last year).

In step 260, reputation server 150 provides the reputation score for the email to another set of recipients of the email For example, reputation server 150 may send the computed reputation score to one or more email clients (and/or server application) used by the another set of recipients to access the email, which in turn may display (in the form of text or using appropriate graphical elements such as icons, colors, etc.) the reputation score to the another set of recipients.

In step 280, reputation server 150 determines whether continued monitoring of the email is required to be performed. For example, in the scenario that the computed reputation score for the email is a lower range of negative values (e.g. −80 to −100), reputation server 150 may send an indication to the email clients (and/or server application) to block access to the email and determine that continued monitoring of the email is not required. Alternatively, if the email has been opened by all the recipients and/or all the remaining recipients (in the second set) have a positive hygiene score, reputation server 150 may determine that continued monitoring of the email is not required. For all other scenarios, reputation server 150 may determine that continued monitoring of the email is required.

If continued monitoring is determined to be required (value “YES”), control passes to step 220, with reputations server 150 again performing the steps of 220, 240, 260 and 280 at a future time instance. In one embodiment, reputation server 150 identifies a new (third) set of recipients who have opened the (same) email at a future time instance, computes a new value for the reputation score based on hygiene scores of the third set of recipients and updates the reputation score for the email to the new value (by sending the new value to the email clients and/or server application). If continued monitoring of the email is determined to be not required (value “NO”), control passes to step 299, where the flowchart ends.

Thus, reputation server 150 provides protection against malicious attacks propagated via emails. The manner in reputation server 150 may be implemented to provide several aspects of the present disclosure according to the steps of FIG. 2 is described below with examples.

### 4. EXAMPLE IMPLEMENTATION

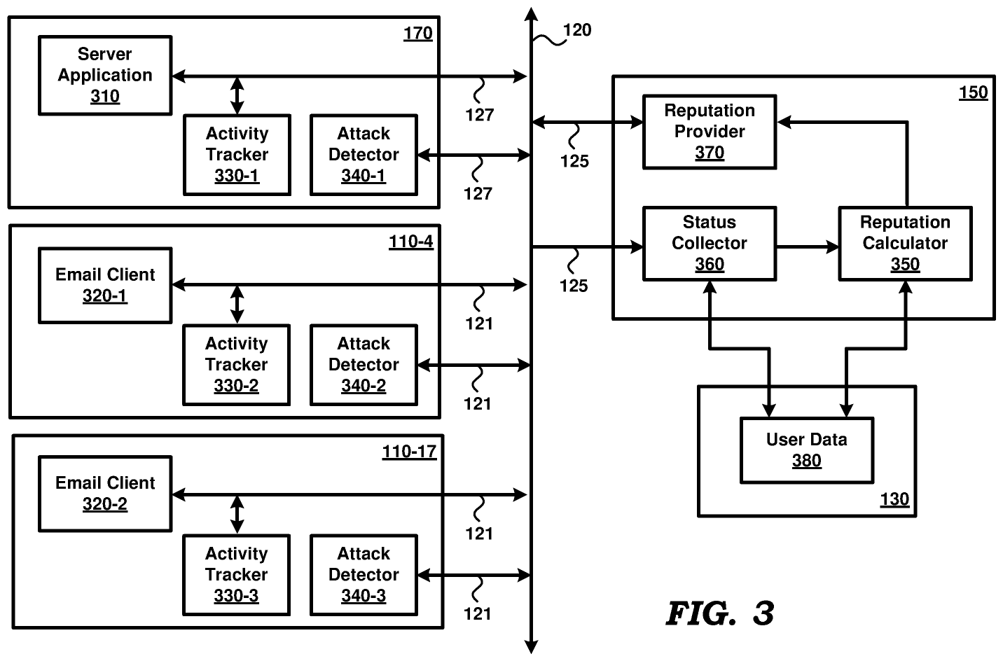

FIG. 3 is a block diagram illustrating the manner in which protection against malicious attacks propagated via emails is implemented in one embodiment. The block diagram is shown containing server application 310, email clients 320-1 & 320-2, activity trackers 330-1, 330-2, & 330-3, attack detector 340-1, 34-2 & 340-3, status collector 360, score calculator 350, score provider 370 and user data 380.

Status collector 360, score calculator 350, score provider 370 are shown implemented as part of reputation server 150, while user data 380 is shown maintained in data store 130. However, in alternative embodiments, status collector 360 may be implemented external to reputation server 150 (for example, in a backend server, not shown) and/or user data 380 may be maintained internal to reputation server 150, as will be apparent to one skilled in the relevant arts by reading the disclosure herein. Each of the blocks of FIG. 3 is described in detail below.

Server application 310 represents an email server application executing in email server 170, while each of email clients 320-1 and 320-2 represents a corresponding email client (browser application or email client application) respectively executing in end user systems 110-4 and 110-17. Email clients 310-1 and 320-2 provides various user interfaces that enables users/recipients of emails to perform desired activities such as downloading an email from the server, opening an email, clicking a link in the email, opening an attachment contained in an email, etc. Sample user interfaces are described in below sections.

Each of activity trackers 330-1 through 330-3 represents a software application that tracks and records the activity of users/recipients with respect to email communications delivered over network 120. Each activity tracker may be implemented consistent (for example, as plug-ins) with the server application and/or email clients to facilitate the tracking of the user activities with respect to the email communications. Activity trackers 330-1 through 330-3 then forward the details of the each recorded activity to status collector 360 implemented in reputation server 150.

Each of attack detectors 340-1 through 340-3 represents a software application that detects the presence of infections caused by malicious attacks in a corresponding system (email server 170 or end user systems 110-4 and 110-7). In addition, attack detectors may also detect whether the corresponding system has been infected by other malicious software such as computer viruses, worms, Trojan horses, spyware, etc. Each attack detector may be implemented consistent with the system to detect the presence of such infections. Attack detectors 340-1 through 340-3 then forward the details of the infections to status collector 360 implemented in reputation server 150.

Status collector 360 receives the details of the activities performed by various users/recipients of an email from activity trackers 330-1 through 330-3 and determines a corresponding recipient status for each user/recipient of the email. The recipient status for a user may be one of email accessed by not yet opened/read by the user/recipient (“Email Unread”), email has been accessed and opened by the user/recipient (“Email Read”), email has been opened and the user has clicked on a link in the email (“Link Accessed”) or email has been opened and the user has opened an attachment contained in the email (“Attachment Opened”).

Status collector 360 also receives the details of the infections from attack detectors 340-1 through 340-3 and determines a hygiene score for each user. According to an aspect, status collector 360 determines that a user/recipient has a positive hygiene score (e.g. a value between +100 and 1) if the recipient has never caused an infection in a pre-determined duration (e.g. last year) and a negative hygiene score (e.g. a value between −1 and −100) if the recipient has been a cause of at least one infection in the pre-determined duration. A value of 0 for the hygiene score may indicate that the user/recipient is a new user whose data about previous infections is not available.

Status collector 360 stores the determined hygiene scores for each user and also the determined recipient status for each recipient of each email communication as part of user data 380. Status collector 360 may also send an indication (of a change of status in user data 380) to score calculator 350. The manner in which user data may be maintained in data store 130 is described below with examples.

### 5. USER DATA

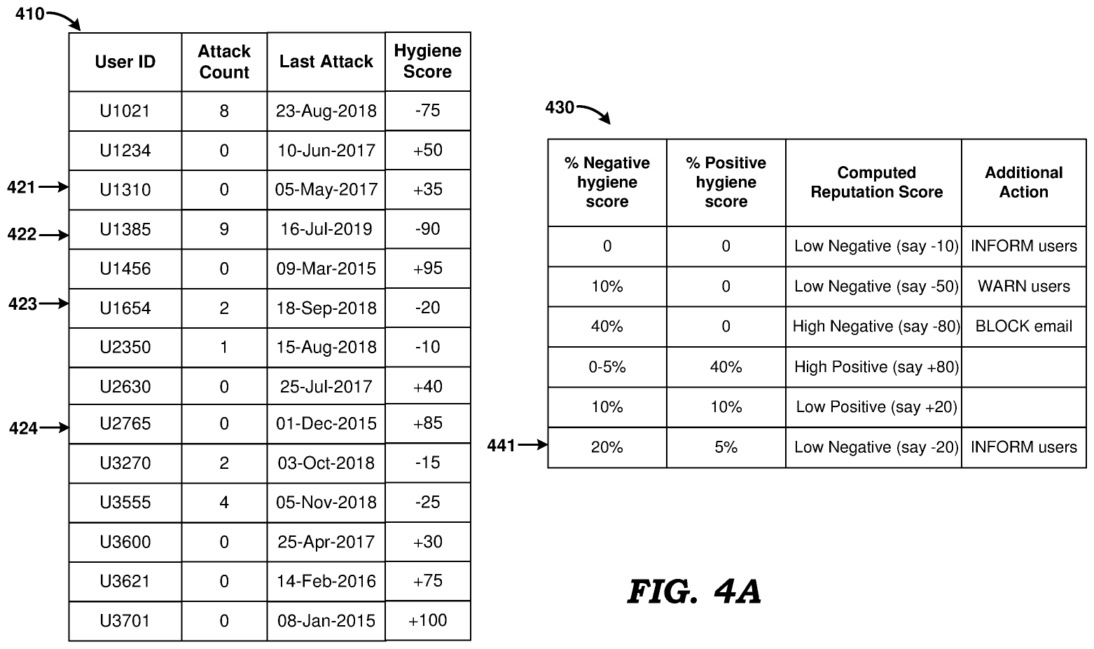

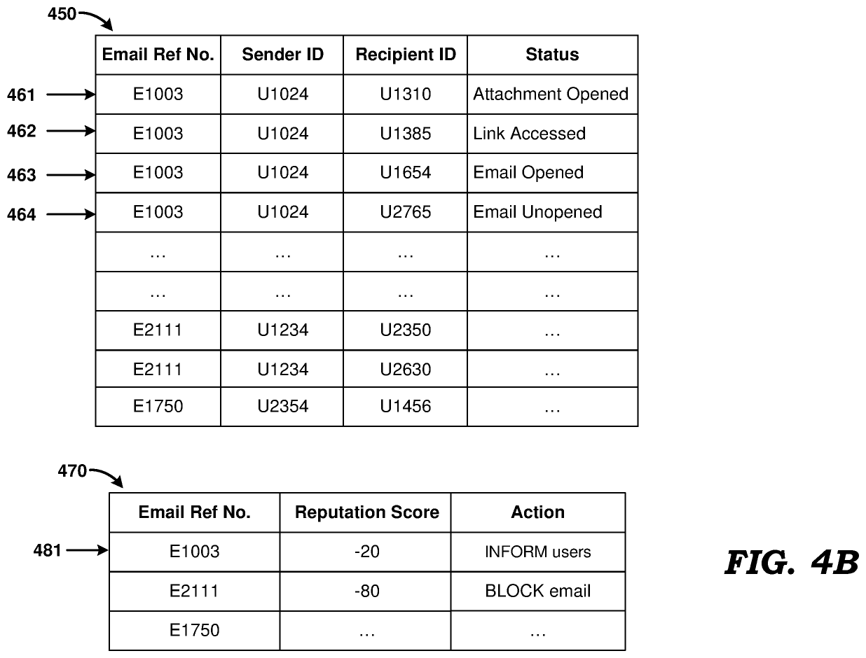

FIGS. 4A and 4B together depicts sample portions of user data (380) maintained for email communications in one embodiment. For illustration, the user data is shown maintained in the form of one or more tables in data store 130 (implemented as a relational database server). However, in alternative embodiments, the user data may be maintained according to other data formats (such as extensible markup language (XML), etc.) and/or using other data structures (such as lists, trees, etc.), as will be apparent to one skilled in the relevant arts by reading the disclosure herein.

Furthermore, for illustration, the email communications are shown associated with corresponding unique email identifiers such as “E1003”, “E2111”, etc. while the users (senders and recipients) are shown associated with corresponding unique user identifiers such as “U1021”, “U1234”, etc. However, in a practical embodiment, the user identifiers may correspond to the email accounts (e.g. user101@acme.com, user200@oracle.com, etc.) associated with each user, while the email identifiers may correspond to email signatures formed from the email accounts of the sender, recipients, and date and time of sending the email, as will be apparent to one skilled in the relevant arts by reading the disclosure herein. Each of the tables of user data (380) is described in detail below.

Referring to FIG. 4A, table 410 specifies the details of the hygiene scores corresponding to various users (e.g. senders, recipients) of email communications. Table 410 is updated by status collector 360 based on the details of the infections received from attack detectors 340-1 through 340-3.

Column “Attack Count” specifies the number of attacks caused by the corresponding user in a pre-determined duration (here, assumed to be “1-Aug-2018” to 31-July-2019”), while column “Last Attack” specifies the date of the last malicious attach caused by the user. It may be readily observed that the rows/users indicated to have 0 attack count are shown having a positive hygiene score, while the users/rows indicated to have at least 1 attack count are shown having a negative hygiene score.

It may be further appreciated that the value of the positive hygiene score is indicative of the duration for which user has never caused an infection (larger value indicating longer duration), while value of the negative hygiene score is indicative of the number of infections caused (larger value indicating higher number). Thus, rows 424 and 421 (having the values “+85” and “+35”) indicates that user “U2765” has not caused an infection longer than the user “U1310”, while rows 422 and 423 (having the values “−90” and “−20”) indicates that user “U1385” has caused more infections than user “U1654”.

Table 430 of FIG. 4A specifies a rules data based on which a reputation score of an email communication is computed based on the hygiene scores of the recipients of the email. Column “Computed Reputation Score” specifies a range of values that may be computed for the reputation score based on a corresponding percentage of negative and positive hygiene score recipients who have opened the email communication (indicated in columns “% Negative hygiene score” and “%Positive hygiene score”). Column “Additional Action” specifies any additional actions that a server application/email client has to performs based on the computed reputation score. For example, when the reputation score is a High Negative value, the additional action may be to BLOCK the email so that other users/recipients of the mail are unable to open the email.

Referring to FIG. 4B, table 450 specifies the recipient status of the email communications delivered over a network (120) and monitored by reputation server 150. Table 450 is updated by status collector 360 based on the details of the activities received from activity trackers 330-1 through 330-3.

Rows 461-464 specifies the recipient status corresponding to different recipients of the same email communication having reference no. “E1003”. It may be readily observed that the recipients specified in rows 461-464 of table 450 have corresponding hygiene scores indicated in rows 421-424 of table 410. Similarly, the other rows specify the recipient status of other email communications monitored by reputation server 150.

Table 470 of FIG. 4B specifies the reputation scores computed for different email communications delivered over a network (120) and monitored by reputation server 150. Table 470 also specifies any server/client action to be performed for each email communication. Row 481 specifies the reputation score “−20” computed for the email communication having reference no. “E1003” based on the hygiene scores of the recipients indicated in rows 461-464 of table 410. The manner in which reputation server 150 computes a reputation score for an email based on the hygiene scores of the recipients of the email is described below with examples.

### 6. COMPUTING REPUTATION SCORE

Referring again to FIG. 3, score calculator 350 computes a reputation score for each email communication monitored by reputation server 150. The computation may be performed in response to the indication from status collector 360 or may be performed periodically (say, every 5 minutes). Score calculator 350 first determines the set of recipients who have opened (and interacted) with each email communication, that is, the users having the recipient status of one of “Email Read”, “Link Accessed” and “Attachment Opened”. Thus, for the email “E1003”, score calculator 350 determines that the set of recipients includes the recipients in rows 461-463 (and not row 464), that is, {“U1310”, “U1385”, “U1654”}.

Score calculator 350 then computes the reputation score for the email based on the rules data specified in table 430. Broadly, the reputation score is computed as a negative value (e.g. 0 to −100) if the number of recipients having negative hygiene score in the set of recipients is greater than the number of recipients having positive hygiene score in the set and a positive value (e.g. +1 to +100) otherwise.

Score calculator 350, accordingly, first identifies (based on table 410) the hygiene scores of the set of recipients who have opened the email. For email “1003”, score calculator 350 determines the hygiene scores of the users in the set as being {+35, −90, −20} as indicated by rows 421-423 of table 410. As the number of negative hygiene score recipients (2) is greater than the number of positive hygiene score recipients (1), score calculator 350 determines that the rule specified in row 441 of table 430 is applicable and accordingly computes the reputation score for the email as a low negative value (−20, for illustration). Score calculator 350 also determined any additional actions that need to be performed for the email (such as “INFORM users” for email “E1003”).

Score calculator 350 then stores the computed reputation score (and also additional action) as part of user data 380 (in particular, in table 470 noted above). Similarly, score calculator 350 computes the reputation scores for the different email communications being monitored, and updates user data 380. After storing, score calculator 350 also forwards the computed reputation score and the additional action for the email communication to score provider 370.

Score provider 370 receives the computed reputation score and the additional action for the email communication from store calculator 350, and then provides the reputation score and additional action to each of server application 310 and email clients 320-1 and 320-2. For example, the reputation score and additional action may be provided in the form of push notification sent by score provider 370. Alternatively, each of server application 310 and email clients 320-1 and 320-2 may be designed to send a request to reputation server 150 (in particular to score provider 370) for the reputation score of an email communication, with score provider 370 then sending the computed reputation score (and additional action) as a response to the request (thus, implementing a “pull” based notification).

Each of server application 310 and email clients 320-1 and 320-2 may then display the reputation score (and perform the additional action) associated with the email communication. Some user interfaces that may be provided to users accessing email communications are described below with examples.

### 7. SAMPLE USER INTERFACES

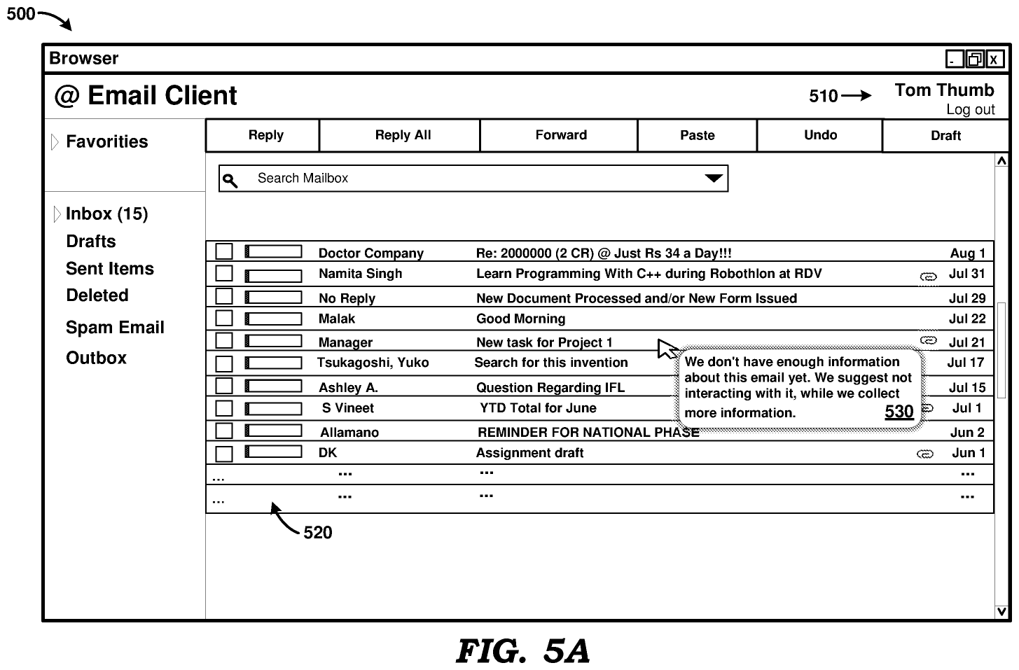

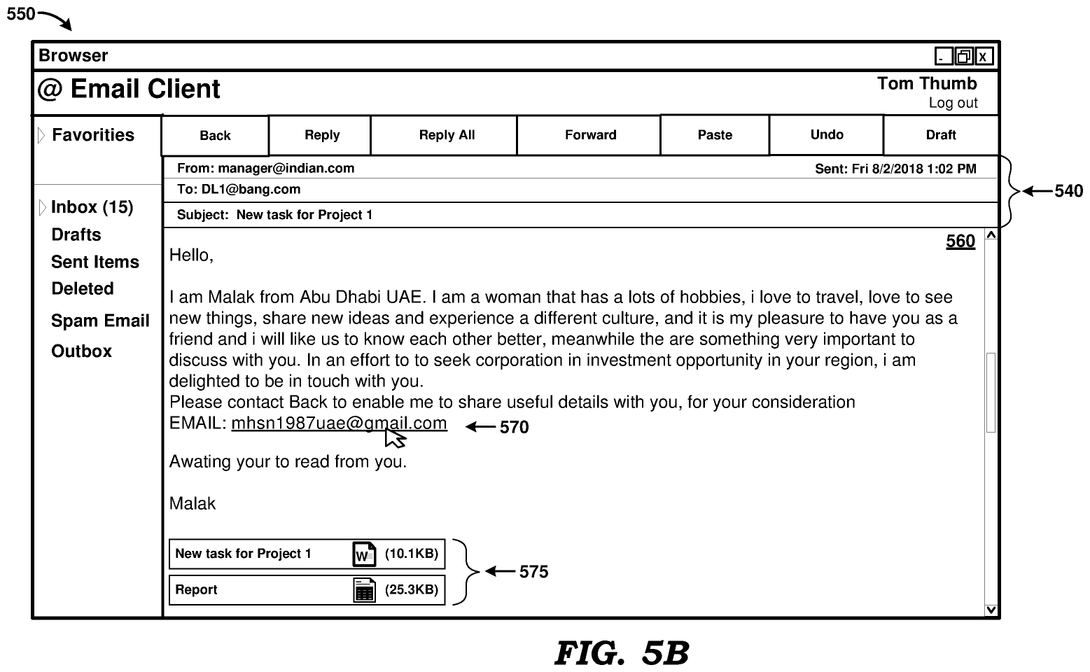

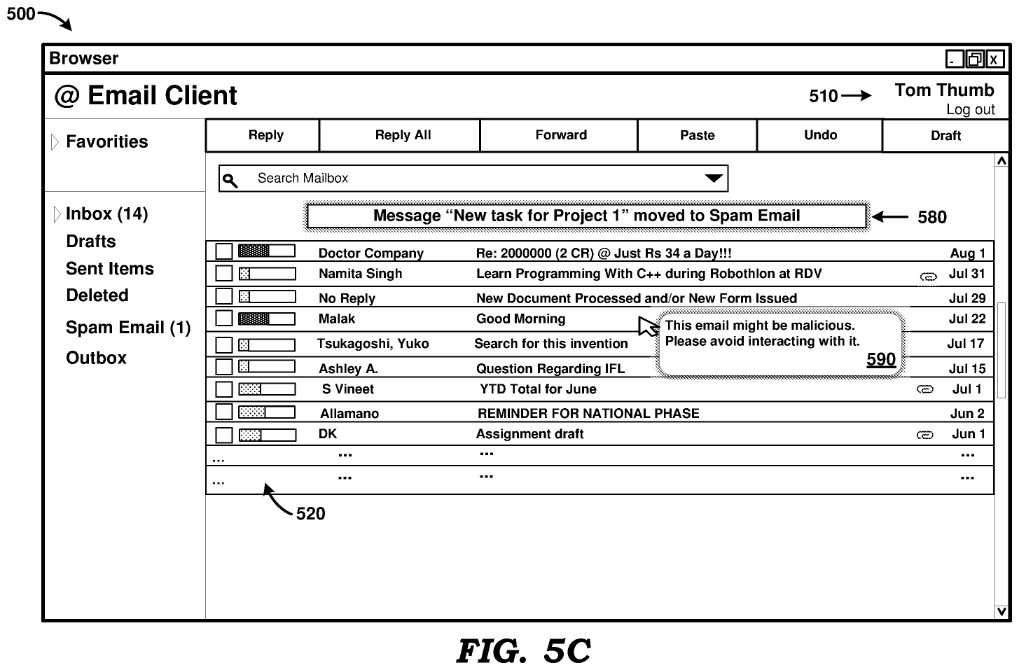

FIGS. 5A-5C depicts sample user interfaces provided to users accessing email communications in one embodiment. Each of display area 500 of FIGS. 5A/5C and display area 550 of FIG. 5B represent a portion of a user interface displayed on a display unit (not shown) associated with one of end user systems 110. The user interfaces may be provided by email clients (e.g. 320-1, 320-2) executing in the end user system 110. In one embodiment, each user interface corresponds to a web page provided by server application 310 executing in email server 170 and rendered by a browser executing on end user systems 110.

Referring to FIG. 5A, display area 500 depicts an email home screen displayed to a specific user named “Tom Thumb” as indicated by display area 510. Specifically, the home screen displays a listing of the email communications received by the user (in other words, where the user is indicated to be a recipient of the email communications). The listing is shown containing rows corresponding to the received emails, with columns indicating sender name, subject line, and indication of whether attachments are included in the email or not, sent date, etc. as is well known in the relevant arts.

Column 520, provided according to an aspect of the present disclosure, displays a respective reputation score associated with each of the received email communications. The reputation score is shown in the form of a bar, with the pattern indicating whether the reputation score is negative (darker pattern) or positive (lighter pattern), and the percentage of the bar filled indicating the value (from 0 to 100) of the score.

In one embodiment, each of the email communications that have not been opened by any of the corresponding recipients is associated with a low negative score (such as −10) and the additional action of “INFORM users” about the email. As such, when the user tries to select a desired email (as indicated by the mouse pointer), an information message is shown to the user as indicated by display area 530. The description is continued assuming that the user has selected the desired email for viewing the content of the email (in spite of the warning message).

Referring to FIG. 5B, display area 550 depicts a view email screen displayed to the user in response to the user selecting a desired email from the listing of emails in FIG. 5A. In particular, display area 540 displays the header details of the email such as the sender name, list of recipient names, subject line and sent date. Display area 560 displays the content of the email including link 570 and attachments 575.

In one embodiment, an email is deemed to be opened/read by a user/recipient when the recipient uses the interface of FIG. 5B to view the contents of the email. In addition, the recipient may interact with the content of the email (shown in display area 560) such as clicking on link 570 and/or opening one or more of attachments 575.

Similarly, using the interface of display area 550, different recipients of an email may open (and/or interact with) the email at different time instances. In response to such opening/interactions, reputation server 150 computes a new value for the reputation score of the email (at a future time instance) and then updates the reputation score to the new value. The new values of the reputation score (at the future time instance) may then be displayed to the users as described below with examples.

Referring to FIG. 5C, display area 500 there depicts the email home screen of the user “Tom Thumb” updated at a future time instance. It may be readily observed that the bars in column 520 reflect the new values of the reputation scores for the corresponding email communications.

In one embodiment, when an email has the addition action of BLOCK email (when the reputation score is a High Negative value), the email is automatically (without any manual intervention) marked as SPAM/BLOCKED, the email is moved to the “Spam Email” folder, and a message regarding the move is displayed to the user. Display area 580 indicates that the email having the subject line “Assignment Draft” has been moved to the “Spam Email” folder, in view of the BLOCK email action (and the High Negative reputation score) received for the email.

Similarly, when an additional action of WARN users is received for an email communication, when the user tries to select the email (as indicated by the mouse pointer), a warning message is shown to the user as indicated by display area 590. It may be appreciated that by moving the email to “Spam Email” folder and by displaying the warning message (of display area 590), the recipients who have not yet opened the email are discouraged to open the email

Thus, reputation server 150 provides protection against malicious attacks propagated via emails. According to an aspect, the set of recipients who have opened an email may belong to a first enterprise, while the set of recipients to whom the reputation server is provided belongs to a second enterprise (different from the first enterprise). The manner in which protection against malicious attacks propagated via emails is provided across multiple different enterprises is described below with examples.

### 8. PROTECTION ACROSS MULTIPLE ENTERPRISES

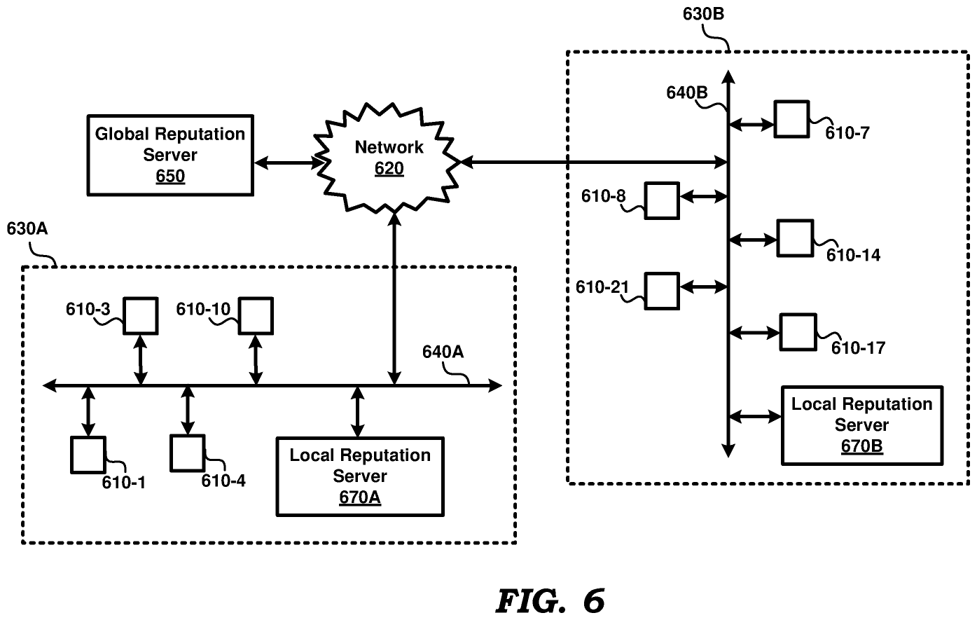

FIG. 6 is a block diagram illustrating the manner in which protection against malicious attacks propagated via emails is provided across multiple enterprises in one embodiment. The block diagram is shown containing internet 620, enterprise computing systems 630A and 630B and global reputation server 650.

Enterprise computing system 630A may be owned by a first enterprise, while enterprise computing system 630B may be owned by a second enterprise (different from the first enterprise). Enterprise computing system 630A is shown containing some enterprise nodes (610-1, 610-4, etc.), intranet 640A and local reputation server 670A, while enterprise computing system 630B is shown containing some other enterprise nodes (610-14, 610-21, etc.), intranet 640B and local reputation server 670B.

Merely for illustration, only representative number/type of blocks and/or enterprises is shown in FIG. 6. Many environments often contain many more blocks and/or enterprises, both in number and type, depending on the purpose for which the environment is designed. Each block of FIG. 6 is described below in further detail.

Internet 620 represents a data network providing connectivity between global reputation server 650 and various systems present in enterprise computing systems 630A and 630B.

Internet 620 may encompass the world-wide connected Internet. Internet 120 may be implemented using protocols such as Transmission Control Protocol (TCP) and/or Internet Protocol (IP), well known in the relevant arts.

Each of intranet 640A and 640B provides connectivity between various nodes of the corresponding enterprise computing system 630A and 630B, while also extending the connectivity to various other devices accessible via internet 120. Each of intranet 640A and 640B may be implemented as local area networks (e.g., using wireless and wire-based technologies) supporting TCP/IP protocols.

Each of enterprise nodes 610-1, 610-4, etc. represents a system/server operating within the corresponding enterprises. Each enterprise node may correspond to an end user system similar to end user systems 110 of FIG. 1, an email server similar to email server 170 of FIG. 1 or a storage server similar to data store 130 of FIG. 1, and according their description is not repeated here for conciseness. Enterprise nodes 610-1, 610-4, etc. are collectively or individually referred by referral numeral 610, as will be clear from the context.

Each of local reputation server 670A and 670B represents a reputation server provided according to several aspects of the present disclosure. The operation of each local reputation server is similar to reputation server 150 of FIG. 1 described in detail above, and accordingly the description is not repeated here for conciseness. In addition to performing the actions of reputation server 150, each local reputation server 670A/670B also updates the global reputation server 650 of any changes to the user data of FIGS. 4A/4B with respect to the users/recipients in the corresponding enterprise.

Global reputation server 650 receives the details of the user data from different local reputation servers, updates a global user data (similar to the data of FIGS. 4A/4B), computes reputation scores for each email communication and provides the reputation scores to the local reputation servers (670A/670B), while in turn may provide the reputation scores to the enterprise nodes 610 in the corresponding enterprise. Alternatively, global reputation server 650 may provide the reputation scores directly to enterprise nodes 610.

Thus, aspects of the present disclosure provide for protection against malicious attacks propagated via emails across multiple different enterprises. It may be appreciated that the users/recipients of the second enterprise (630B) are able to avail the experience of the users of the first enterprise (630A) and accordingly reduce the probability of malicious attacks in the second enterprise.

It should be further appreciated that the features described above can be implemented in various embodiments as a desired combination of one or more of hardware, software, and firmware. The description is continued with respect to an embodiment in which various features are operative when the software instructions described above are executed.

### 9. DIGITAL PROCESSING SYSTEM

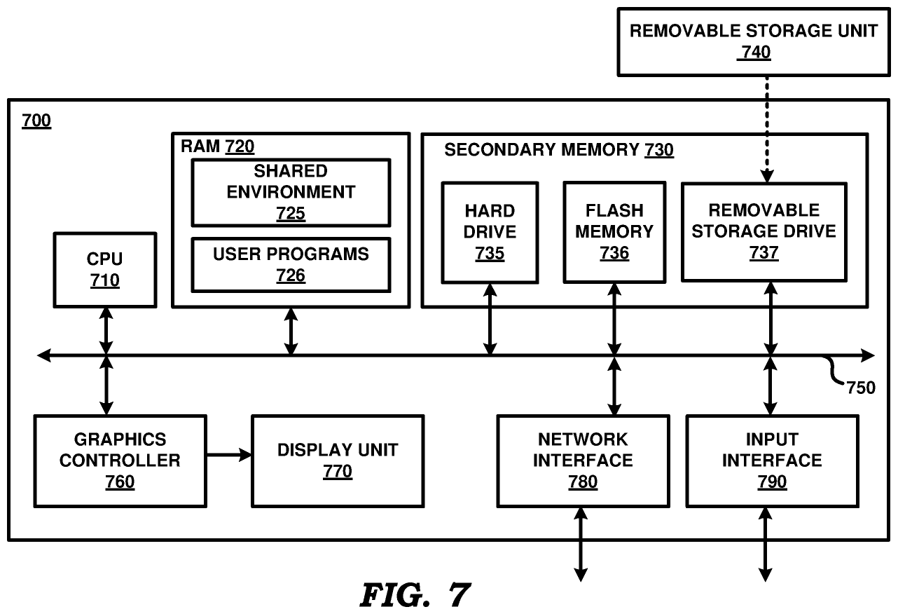

FIG. 7 is a block diagram illustrating the details of digital processing system 700 in which various aspects of the present disclosure are operative by execution of appropriate executable modules. Digital processing system 700 may correspond to one of end user systems 110/610, reputation server 150/650/670A/670B, or email server 170.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or other user programs 726 (such as other applications, DBMS, etc.). In addition to shared environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals (for example, the portions of the user interfaces shown in FIGS. 5A-5C). Input interface 790 may correspond to a keyboard and a pointing device (e.g., touch-pad, mouse) and may be used to provide inputs (for example, the inputs associated with the user interfaces shown in FIGS. 5A-5C). Network interface 780 provides connectivity to a network (e.g., using Internet Protocol), and may be used to communicate with other systems (of FIG. 1) connected to the networks (120).

Secondary memory 730 may contain hard drive 735, flash memory 736, and removable storage drive 737. Secondary memory 730 may store the data (for example, data portions shown in FIGS. 4A and 4B) and software instructions (for example, for implementing the various features of the present disclosure as shown in FIG. 2, etc.), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 10. CONCLUSION

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of protecting users from malicious attacks propagated via emails, the method comprising:
identifying a first set of recipients of an email who have opened the email;
computing a reputation score for the email based on hygiene scores of the first set of recipients, wherein the reputation score indicates a probability of malicious attacks being propagated via the email; and
providing the reputation score for the email to a second set of recipients of the email.

2. The method of claim 1, wherein when the email contains a link or an attachment, the identifying identifies the first set of recipients who have opened the email and accessed the link or the attachment contained in the email.

3. The method of claim 2, wherein the identifying and the computing is performed at a first time instance, the method further comprising:
continuing to monitor the email to identify a third set of recipients who have opened the email at a second time instance after the first time instance, and to compute a new value for the reputation score based on hygiene scores of the third set of recipients; and
updating the reputation score for the email to the new value.

4. The method of claim 2, wherein the email is addressed to a plurality of recipients, the first set of recipients and the second set of recipients being contained in the plurality of recipients,
wherein the second set of recipients of the email include at least some of those of the plurality of recipients not contained in the first set of recipients.

5. The method of claim 4, wherein the first set of recipients belong to a first enterprise and the second set of recipients belong to a second enterprise.

6. The method of claim 2, wherein each recipient is deemed to have a positive hygiene score if the recipient has never caused an infection in a pre-determined duration and a negative hygiene score if the recipient has been a cause of at least one infection in the pre-determined duration.

7. The method of claim 6, wherein the reputation score for the email is computed as a negative value if the number of recipients having negative hygiene score in the first set of recipients is greater than the number of recipients having positive hygiene score in the first set of recipients and a positive value otherwise,
wherein the negative value of the reputation score indicates a high probability of malicious attacks being propagated via the email.

8. A non-transitory machine readable medium storing one or more sequences of instructions for protecting users from malicious attacks propagated via emails, wherein execution of the one or more instructions by one or more processors contained in a reputation sever enables the reputation server to perform the actions of:
identifying a first set of recipients of an email who have opened the email;
computing a reputation score for the email based on hygiene scores of the first set of recipients; and
providing the reputation score for the email to a second set of recipients of the email.

9. The non-transitory machine readable medium of claim 8, wherein when the email contains a link or an attachment, the identifying identifies the first set of recipients who have opened the email and accessed the link or the attachment contained in the email.

10. The non-transitory machine readable medium of claim 9, wherein the identifying and the computing is performed at a first time instance, further comprising one or more instructions for:
continuing to monitor the email to identify a third set of recipients who have opened the email at a second time instance after the first time instance, and to compute a new value for the reputation score based on hygiene scores of the third set of recipients; and
updating the reputation score for the email to the new value.

11. The non-transitory machine readable medium of claim 9, wherein the email is addressed to a plurality of recipients, the first set of recipients and the second set of recipients being contained in the plurality of recipients,
wherein the second set of recipients of the email include at least some of those of the plurality of recipients not contained in the first set of recipients.

12. The non-transitory machine readable medium of claim 11, wherein the first set of recipients belong to a first enterprise and the second set of recipients belong to a second enterprise.

13. The non-transitory machine readable medium of claim 9, wherein each recipient is deemed to have a positive hygiene score if the recipient has never caused an infection in a pre-determined duration and a negative hygiene score if the recipient has been a cause of at least one infection in the pre-determined duration.

14. The non-transitory machine readable medium of claim 13, wherein the reputation score for the email is computed as a negative value if the number of recipients having negative hygiene score in the first set of recipients is greater than the number of recipients having positive hygiene score in the first set of recipients,
wherein the negative value of the reputation score indicates a high probability of a malicious attack being propagated via the email.

15. A digital processing system comprising:
a processor;
a random access memory (RAM);
a machine readable medium to store one or more instructions, which when retrieved into the RAM and executed by the processor causes the digital processing system to perform the actions of:
identifying a first set of recipients of an email who have opened the email;
computing a reputation score for the email based on hygiene scores of the first set of recipients; and
providing the reputation score for the email to a second set of recipients of the email.

16. The digital processing system of claim 15, wherein when the email contains a link or an attachment, the digital processing system identifies the first set of recipients who have opened the email and accessed the link or the attachment contained in the email.

17. The digital processing system of claim 16, wherein the identifying and the computing is performed at a first time instance, the digital processing system further performing the actions of:
continuing to monitor the email to identify a third set of recipients who have opened the email at a second time instance after the first time instance, and to compute a new value for the reputation score based on hygiene scores of the third set of recipients; and
updating the reputation score for the email to the new value.

18. The digital processing system of claim 16, wherein the email is addressed to a plurality of recipients, the first set of recipients and the second set of recipients being contained in the plurality of recipients,
wherein the second set of recipients of the email include at least some of those of the plurality of recipients not contained in the first set of recipients.

19. The digital processing system of claim 18, wherein the first set of recipients belong to a first enterprise and the second set of recipients belong to a second enterprise.

20. The digital processing system of claim 16, wherein each recipient is deemed to have a positive hygiene score if the recipient has never caused an infection in a pre-determined duration and a negative hygiene score if the recipient has been a cause of at least one infection in the pre-determined duration.
wherein the reputation score for the email is computed as a negative value if the number of recipients having negative hygiene score in the first set of recipients is greater than the number of recipients having positive hygiene score in the first set of recipients,
wherein the negative value of the reputation score indicates a high probability of a malicious attack being propagated via the email.
